(19) United States
(12) Patent Application Publication
(10) Pub. No.: US 2008/0135343 A1
(43) Pub. Date: Jun. 12, 2008

(54) ELEVATOR SUPPORT MEANS FOR AN ELEVATOR SYSTEM, ELEVATOR SYSTEM WITH SUCH AN ELEVATOR SUPPORT MEANS AND METHOD FOR ASSEMBLING SUCH AN ELEVATOR SYSTEM

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/837,041

(22) Filed: Aug. 10, 2007

Related U.S. Application Data
(60) Provisional application No. 60/822,118, filed on Aug. 11, 2006.
(60) Provisional application No. 60/871,869, filed on Dec. 26, 2006.

(30) Foreign Application Priority Data
Aug. 11, 2006 (EP) 06118824.9
Dec. 22, 2006 (EP) 06127168.0

(51) Int. Cl. B66B 11/08; B23P 19/00

(52) U.S. Cl. 187/266; 29/700

(57) ABSTRACT

An elevator support for an elevator system includes a base body, a drive side with at least one drive rib, a deflecting side opposite the drive side with at least one guide rib, and a tensile carrier arrangement arranged in the base body. The guide rib has a greater flank height and/or a greater flank width than the drive rib. A ratio of the flank height of the guide rib to the width of the elevator support is at least 0.4. A respective guide rib is associated with at most three of the drive ribs.

### CROSS-REFERENCE TO RELATED APPLICATION

This application claims the benefit of U.S. provisional patent application Ser. No. 60/822,118 filed Aug. 11, 2006 and U.S. provisional patent application Ser. No. 60/871,869 filed Dec. 22, 2006.

### FIELD OF THE INVENTION

The present invention relates to an elevator support means for an elevator system, to an elevator system with such an elevator support means and to a method for assembling such an elevator system.

### BACKGROUND OF THE INVENTION

In an elevator system, one or more elevator support means transmit forces from a drive to a car movable in an elevator shaft or along free-standing guide rails. A car can be coupled by way of the same or further support elevator support means to a compensating weight or counterweight which travels in opposite sense to the car.

Such an elevator system with an elevator support means is known from European patent EP 1 446 348 B1. In an example of embodiment the elevator support means has on a drive side five drive ribs of wedge-ribbed shape for engagement with a drive wheel and on a deflecting side opposite the drive side a guide rib similarly of wedge-ribbed shape for engagement with a deflecting wheel. Guide ribs and drive ribs engage in corresponding wedge-shaped grooves which are formed on deflecting and drive wheels.

A rib generally has two mutually opposite flanks which include a flank angle α as schematically indicated in FIG. 2. In a wedge rib these flanks are generally inclined relative to one another and in a rectangular rib they are parallel to one another with a flank angle α=0°. In the present case the projection of the flank onto the plane spanned by the longitudinal and transverse direction of the elevator support means is termed flank width “t”. In a rectangular rib, for example, it is equal to zero and in a wedge rib with a flank length “f” the inclined flanks are generally t=f×sin(α/2). Correspondingly, the projection of the flank onto the median or longitudinal plane of the base body is termed flank height “h”. It corresponds, for example, in a rectangular rib with the flank length “f” and in a wedge rib is generally h=f×cos(α/2).

Due to the wedge effect the drive ribs of wedge-ribbed shape increase, for the same tension force in the elevator support means, the normal forces acting on the flanks of the drive ribs and thus the drive capability of the drive. In addition, they advantageously guide the elevator support means in transverse direction on the drive wheel.

The guide rib at the rear side guides the elevator support means in transverse direction on deflecting wheels over which the elevator support means is deflected so as to co-operate with, for example, the car or the counterweight.

It has proved advantageous to arrange the tensile carrier arrangement at not too wide a distance and at a spacing from the drive side or the flanks of the drive ribs which is as uniform as possible so as to provide a more homogenous distribution of force in the drive ribs. This results in drive ribs with smaller flank height and flank width as well as a flatter flank angle.

The elevator support means usually rests from above on a drive wheel of the elevator system so that it is redisposed by its own weight in the grooves in the drive wheel circumference. Conversely, it frequently loops around deflecting wheels laterally or from below so that its own weight does not redispose it or even urge it out of the grooves in the deflecting wheel circumference. If slackening of the elevator support means occurs due to, for example, inertias of the car or the counterweight or oscillations in the elevator support means this can have the consequence that a guide rib slides completely out of the associated groove in the deflecting wheel. Without the then absent transverse guidance on the deflecting wheel a diagonal tension, which is usually present in the elevator system due to assembly tolerances, twistings of the load run and the like, has the effect that the elevator support means then migrates in transverse direction from its desired position and the guide rib also no longer finds its way back into the groove in the deflecting wheel when the elevator support means tightens again.

The elevator support means usually loops around a drive wheel of the elevator system with a greater angle of wrap than deflecting wheels so as to prevent, at the drive wheel, slipping of the elevator support means in correspondence with the Euler-Eytelwein formula. Accordingly, a drive rib frequently engages over a greater angular range in a drive wheel than a guide rib in a deflecting wheel. In addition, in a deflecting wheel with a smaller angle of wrap the forces in radial direction, which constrain the rib in the groove at the wheel circumference, are less than in the drive wheel with greater angle of wrap. If, for example, the elevator support means loops around a drive wheel by 180°, but a deflecting wheel by only 90°, the resultant radial force on the elevator support means is then greater at the drive wheel by the factor √2 than at the deflecting wheel.

In addition, the stronger diagonal running, which is caused by, for example, assembly tolerances, of the elevator support means frequently occurs between adjacent deflecting wheels. Moreover, compensation for this by deformation of the elevator support means also cannot be sufficiently provided due to the frequently smaller spacings between adjacent deflecting wheels. The diagonal tension resulting therefrom seeks to displace the elevator support means on the deflecting wheels in transverse direction.

### SUMMARY OF THE INVENTION

It is therefore the object of the present invention to improve the guidance of an elevator support means at its deflection side.

An elevator support means according to the present invention comprises a base body, a drive side, which is provided for friction-coupling engagement with the drive wheel of a elevator system and has at least one drive rib, and a deflecting side, which is disposed opposite the drive side and which is provided for contact with a deflecting wheel of the elevator system and has at least one guide rib. A tensile carrier arrangement is arranged in the base body for transmission of the tension forces.

When in the following reference is made to at least one drive rib or at least one guide rib in that case always several drive ribs or guide ribs can equally well be comprehended, wherein a feature defined for at least drive rib or guide rib then applies to at least one of these several drive or guide ribs, preferably for several drive and/or guide ribs, particularly preferably for all drive and/or guide ribs, of the support means.

According to a first embodiment of the present invention at least one, preferably each, guide rib now has a greater flank height than at least one, preferably each, drive rib. This ensures better guidance of the elevator support means in transverse direction.

The flank height determines the radial displacement which the elevator support means experiences relative to a drive or deflecting wheel before the rib exits entirely from an associated groove in the outer circumference of the drive or deflecting wheel and can no longer guide the elevator support means in transverse direction.

Through the extension of the flank height of the guide ribs relative to the drive ribs partial compensation can be provided for the effects identified above and at the same time a more homogenous forced distribution between the drive side and the tensile carrier arrangement can be realized.

The higher guide rib can, in the case of a microscopic or macroscopic slackening of the elevator support means, move radially further away from a deflecting wheel without the transverse guidance being completely lost. If the elevator support means tightens again, the guide rib, which always still enters partly into the groove of the deflecting wheel due to its greater flank angle, advantageously centers the elevator support means again on the deflecting roller. In addition, the flank area, which engages in the groove in the deflecting wheel circumference, of the guide rib increases and can thus ensure a sufficient transverse guidance even with smaller deflecting angles. A greater diagonal tension up to 4% can therefore preferably also be realized by an elevator support means according to the first embodiment of the present invention.

Through the drive rib, which is lower by comparison, the change in spacing and/or the maximum spacing of the tensile carriers from the drive side can at the same time be reduced so that a more homogenous distribution of force in the drive rib is achieved.

Preferably the ratio of the flank height of at least one, preferably each, guide rib to the flank height of at least one, preferably each, drive rib is at least 1.5, preferably at least 2.0 and particularly preferably at least 2.5. A ratio of at least 1.5 can, for example, be sufficient in order to provide compensation for the deterioration in guidance on a deflecting wheel due to a smaller angle of wrap. A ratio of at least 2.0 can, for example, be advantageous in order to provide compensation for the deterioration in the guidance on a deflecting wheel due to the intrinsic weight which does not return the elevator support means to its position on the deflecting wheel or even sets it away from this. A ratio of at least 2.5 can, for example, be advantageous in order to make possible a greater diagonal tension.

Additionally or alternatively to the greater flank height at least one, preferably each, guide rib can have a greater flank width than at least one, preferably each, drive rib. This, too, guarantees better guidance of the elevator support means in transverse direction.

The flank width determines the offset in the transverse direction by which a rib can run into a groove or run out of this and yet is automatically guided back into the groove, in other words the “capture range” within which a rib is still captured by a groove of a drive or deflecting wheel. Due to the fact that in accordance with the present invention the flank width of the guide rib is greater than the flank width of the drive rib, thus the guide rib is wider in transverse direction, a more homogenous distribution of force in the drive rib can be provided in the narrower drive rib due to the resulting smaller spacing of the tensile carriers from the drive side, whilst the elevator support means when deflected over a deflecting wheel at the same time has better guidance due to the wider guide rib.

This can similarly provide partial compensation for the above-explained effects of poorer guidance and/or stronger diagonal tension due to its intrinsic weight or a smaller angle of wrap at the deflecting side. In the event of microscopic or macroscopic slackening of the elevator support means the wider guide rib can displace more strongly in transverse direction on a deflecting wheel without completely losing transverse guidance. When the elevator support means tightens again the guide rib, which due to its greater flank width always still lies partly over the groove of the deflecting wheel, advantageously centers the elevator support means on the deflecting roller again. In addition, the flank area, which engages in the groove in the deflecting wheel circumference, of the guide rib increases and can thus ensure sufficient transverse guidance even in the case of smaller angles of wrap. Thus, a greater diagonal tension can equally be realized with an elevator support means in which the guide rib has a greater flank width than the drive rib.

The ratio of the flank width of at least one, preferably each, guide rib to the flank width of at least one, preferably each, drive rib is preferably at least 1.5, preferably at least 1.75 and particularly preferably at least 2.0. A ratio of at least 1.5, for example, can be sufficient in order to provide compensation for deterioration in the guidance on a deflecting wheel due to a smaller angle of wrap. A ratio of at least 1.75, for example, can be advantageous to provide compensation for deterioration in the guidance on a deflecting wheel due to the intrinsic weight which does not return the elevator support means to its position on the deflecting wheel or even sets it away from this. A ratio of at least 2.0, for example, can be advantageous to make possible a greater diagonal tension.

The above-explained advantages of a greater flank height or flank width of the guide rib by comparison with the drive rib are already self-evident. For preference, however, the two features are combined together so that the higher and wider guide rib can further displace not only in radial direction, but also in axial direction and nevertheless is guided, especially centered, by the guide rib on the deflecting wheel. A greater diagonal tension can thereby be realized at the deflecting wheel, whilst at the same time the more homogenous distribution of force arises due to the lower, narrower drive ribs.

According to a second embodiment of the present invention, additionally or alternatively to the ratio of the flank height and/or flank width of at least one guide rib to at least one drive rib it is provided that the ratio of the flank height of at least one, preferably each, guide rib to the width of the elevator support means is at least 0.4, preferably at least 0.45 and particularly preferably at least 0.5.

The wider the elevator support means is formed, the more inertial mass pushes away from the deflecting wheel when microscopic or macroscopic slackening occurs. Wider elevator support means also permit, due to the geometrical moment of inertia thereof, stronger transverse forces or a stronger diagonal tension, which equally requires better guidance on a deflecting wheel. It has now proved in tests that with the above-mentioned ratios between guide rib height and elevator support means width it is possible to achieve a very good guidance of the elevator support means on a deflecting wheel. In that case a ratio of at least 0.4, for example, can be sufficient to provide compensation for deterioration in the guidance on a deflecting wheel due to a smaller angle of wrap. A ratio of at least 0.45, for example, can be advantageous in order to provide compensation for deterioration in the guidance on a deflecting wheel due to the intrinsic weight which does not return the elevator support means to its position on the deflecting wheel or sets it away from this. A ratio of at least 0.5, for example, can be advantageous in order to make possible a greater diagonal tension.

The ratio of the flank height of at least one guide rib to the width of the elevator support means according to the second embodiment of the present invention can be realized independently of the ratio of the flank height or flank width of the guide rib by comparison with a drive rib in accordance with the first embodiment. For example, the above-explained advantages can result even with high and wide drive ribs in which flank height and/or flank width of drive and guide ribs are substantially the same. However, the two embodiments are preferably combined together so that not only the more homogenous distribution of force in the shorter and/or narrower drive ribs, but also the better guidance characteristics of the high and/or wide guide ribs are achieved, wherein the guide ribs are adapted to the width of the elevator support means.

According to a third embodiment of the present invention, additionally or alternatively to the ratio of the flank height and/or flank width of a guide rib to a drive rib according to the first embodiment and/or additionally or alternatively to the ratio of the flank height of a guide rib to the width of the elevator support means according to the second embodiment at least one, preferably each, drive rib and at least one, preferably each, guide rib is constructed as a wedge rib with a flank angle, wherein the flank angle of at least one, preferably each, drive rib is greater than the flank angle of at least one, preferably each, guide rib.

More acute guide ribs improve the transverse guidance of the elevator support means at the deflecting side thereof and can thus better provide compensation for, for example, the above-explained effects due to the intrinsic weight, a smaller angle of wrap and/or the greater diagonal tension. In particular, greater penetration depths are thus provided by comparison with rib base area without having to widen the elevator support means overall. On the other hand, more obtuse drive ribs lead to a more homogenous distribution of force in the elevator support means, since the spacing of the individual tensile carriers from the drive side is more uniform and also the maximum spacing reduces.

The ratio of the flank angle according to a third embodiment of the present invention can be realized independently of the features of the first or second embodiment. For example, the above-explained advantages can result even with shorter or narrower guide ribs in which the penetration depth is, nevertheless, increased relative to its base area by the more acute flank angle. The third embodiment is, however, preferably combined with the first and/or second embodiment so that the advantageous greater flank height of the guide rib results due to the more acute flank angle.

A flank angle between 60° and 120°, preferably between 80° and 100° and particularly preferably substantially equal to 90° has proved advantageous for a drive rib constructed as a wedge rib so as to on the one hand achieve a sufficient wedge effect and thus increase in the normal force and on the other hand prevent excessive area pressure, material loading and noise output connected therewith and a jamming of the elevator support means.

A flank angle between 60° and 100°, preferably between 70° and 90° and particularly preferably substantially equal to 80° has proved advantageous for a guide rib constructed as a wedge rib so as on the one hand to ensure a sufficient guidance in a groove of a deflecting wheel and on the other hand to avoid excessive area pressures and the loading of the elevator support means connected therewith as well as output of noise which occurs.

According to a fourth embodiment of the present invention it is provided, additionally or alternatively to the flank height and/or flank width of the guide rib according to the first and/or second embodiment and/or additionally or alternatively to the flank angle of the guide rib according to the third embodiment that a respective guide rib is associated with one, two or three guide ribs.

The transverse guidance on a deflecting wheel is particularly advantageous in order to prevent migration of the elevator support means due to diagonal tension, which can result, for example, due to diagonal running of the elevator support means between a drive wheel and a deflecting wheel. The diagonal tension possible between a drive wheel and a deflecting wheel is limited, inter alia, by the number of drive ribs guiding the elevator support means on the drive wheel. It has proved in tests that with one guide rib for at most three, preferably at most two, drive ribs and particularly preferably one drive rib a particularly reliable guidance of the elevator support means can be ensured. In addition, the lever arm between outer drive ribs and the associated guide rib advantageously reduces and thus the torque which acts on the elevator support means and which results from the components of the forces, which act on the inclined flanks, perpendicularly to the flank width.

Advantageously the fourth embodiment is combined with the first, second and/or third embodiment of the present invention. In particular, if in accordance with the first or second embodiment a guide rib is constructed which is high and/or wide by comparison with the drive rib or the elevator support means width and in accordance with the third embodiment a guide rib is constructed which is acute, advantageous guidance and lever conditions occur with a drive-to-guide rib ratio of at most 3:1.

A guide rib is preferably centered between two adjacent drive ribs. The resultant of the area load on a flank of the guide rib is then applied in statically stable manner between the two points of action of the resultant of the area loads on the flanks of the drive ribs. In addition, the elevator support means can in this manner be constructed to be particularly slender.

According to an embodiment of the present invention the ratio of the width of the elevator support means to the height of the elevator support means is at most 0.95, preferably at most 0.93 and particularly preferably at most 0.91.

Thus, in particular, relatively acute and/or high guide ribs can be provided, which due to their flank height ensure good transverse guidance of the elevator support means.

Advantageously, such a slender elevator support means also has a greater geometrical moment of inertia in transverse direction and thus is stiffer than flat belts with respect to bending about the transverse axis. Such an elevator support means therefore experiences a higher degree of biasing back into the straight, undeformed position when deflected around a drive or deflecting wheel. This biasing counteracts jamming of drive or guide ribs of the elevator support means in associated grooves on a drive or deflecting wheel and thus advantageously reduces the risk of jamming.

A further advantage resides in the additional volume of the elevator support means in the direction of its height. This additional volume advantageously damps vibrations and diminishes shocks, which makes the running of such a belt more consistent.

The transmission of the circumferential force between tensile carriers and drive wheel takes place with transient deformation of the elevator support means in shear. The thus-occurring alternating deformations lead, over the long term, to destruction of the elevator support means and thus limit the service life thereof. Here, too, the additional volume of the elevator support means in the direction of its height can advantageously on the one hand reduce the deformations in shear and on the other hand better dissipate the then-created heat over the greater volume and, in particular, over the greater surface area.

The drive side of the elevator support means according to the present invention preferably has at most three, preferably exactly two, drive ribs and the deflecting side exactly one guide rib. Such an elevator support means can be of slender construction and thus realize the advantages explained in the foregoing.

As explained above, it is advantageous to associate one or two flanks of a drive rib with each tensile carrier so as to achieve a more homogenous distribution of force. For this purpose it is thus advantageous to associate one or two tensile carriers with a drive rib. If the drive side has only two or three drive ribs, then a tensile carrier arrangement of two (two drive ribs each with an associated tensile carrier) up to a maximum of six (three drive ribs each with two associated tensile carriers) tensile carriers thus results. If now for fulfillment of different tensile force requirements several elevator support means are connected in parallel, then elevator support means with only two or three drive ribs therefore significantly increase the modularity, because the tensile force transmissible by the combination of parallel elevator support means can thus be graduated significantly more finely and be adapted to the respective requirements.

The flanks of at least one, preferably each, drive rib and/or at least one, preferably each, guide rib can be formed to be planar. This facilitates production and advantageously produces a self-centering of the rib in an associated groove due to the inclination. Equally, the flanks of, for example, at least one, preferably each, guide rib can also be formed to be concave so as to save material and at the same time achieve a large flank height and/or flank width. The flanks of, for example, at least one, preferably each, guide rib can just as well be formed to be convex so as to make available sacrificial material and thus increase the service life of the elevator support means.

According to an embodiment of the present invention the minimum width of one or more drive ribs is greater than the minimum width of the associated grooves of a drive wheel. It can thereby be ensured that the distal flank regions of the drive ribs always completely rest on corresponding counter-flanks of the associated grooves, which still further taper below the completely penetrated drive rib. These counter-flanks thus do not exert, in their groove base, any notch effect on the drive ribs.

A groove with a radius is preferably formed between two adjacent drive ribs, wherein the ratio of this radius to a radius formed at the tip of an associated rib of the drive wheel of the elevator system is less than one, preferably less than 0.75 and particularly preferably less than 0.5. It can thereby be ensured that the rib, which engages between the two adjacent drive ribs, of the drive wheel exerts no or only a small notch effect on the proximal flank regions of the drive ribs.

The base body, one or more drive ribs and/or one or more guide ribs can be of unitary or multi-part construction from an elastomer, particularly polyurethane (PU), polychloroprene (CR), natural rubber and/or ethelene-propylene-diene rubber (EPDM). These materials are particularly suitable for conversion of the friction forces acting on the drive side into tension forces in the tensile carriers and in addition advantageously damp vibrations of the elevator support means. The drive and/or deflecting side can have one or more casings, for example of textile fabric, for protection against abrasion and dynamic destruction.

A unitary construction gives a particularly compact and homogenous elevator support means. If, conversely, a group of one or more drive ribs is of multi-part construction with a group of one or more guide ribs, in that the elevator support means, for example, is of two-part construction from a part comprising the drive ribs and a part connected therewith and comprising the guide ribs, different material characteristics can be provided on the drive side and deflecting side. For example, the drive side can have a lesser hardness, particularly a lesser Shore hardness, and/or a greater coefficient of friction than the deflecting side so as to achieve better drive capability, whereas conversely the lower coefficient of friction of the deflecting side reduces the energy loss during deflection.

For this purpose, in particular, the drive side and/or the deflecting side can additionally or alternatively have a coating of which the coefficient of friction, hardness and/or abrasion resistance differs or differ from the base body. Alternatively to the coating, a vapor deposition or a flocking can also be provided.

Through the multi-part construction of drive and guide rib and/or the coating of drive and/or deflecting side a elevator support means according to the present invention can preferably have coefficients of friction of μ=0.2 to 0.6 on the drive side and/or μ less than or equal to 0.3 on the deflecting side.

As explained in the foregoing, it can be advantageous for the spacing of the tensile carrier arrangement from the drive side to be less than from the deflecting side. A more homogenous distribution of force in the drive rib and at the same time a better guidance of the elevator support means at the deflecting side can thereby be combined. In that case, for example, there can be defined as spacing the maximum spacing of a tensile carrier from a flank, the mean spacing thereof and/or the spacing of the tensile carrier from the point of force action of the resultant of the area load on the flank.

The diameter of the tensile carriers is preferably in the region of 1.5 to 4 millimeters. Such tensile carriers have a sufficient capability of bending around drive and deflecting wheels and on the other hand have a sufficient strength and can be readily embedded in the base body.

According to an embodiment of the present invention each tensile carrier of the tensile carrier arrangement comprises a double-ply core strand with a core wire and two wire layers wrapped about this, and single-ply outer strands, which are arranged around the core strand, with a core wire, and a wire layer wrapped around this. Such a tensile carrier construction, which can have, for example, one core strand with 1+6+12 steel wires and eight outer strands with 1+6 steel wires, has in tests proved advantageous with respect to strength, ease of production and capability of bending.

Advantageously, in that case the two wire layers of the core strand have the same angle of wrap, whilst the one wire layer of the outer strands is wrapped against the wrap direction of the core strand, and the outer strands are wrapped around the core strand opposite to the wrap direction of their own wire layer. The tensile carrier thus has the order SSZS or ZZSZ. This reduces stretching of the strands.

As mentioned in the foregoing, a modular construction of an elevator support means composite of several elevator support means according to the present invention is advantageous in order to provide different tensile force requirements. In that case the elevator support means are guided parallel to the drive wheel and deflecting wheel.

In this connection, two elevator support means can be spaced apart by a gap. This simplifies mounting and allows slight deformations of the individual elevator support means without these rubbing against one another or mutually working out of the grooves of the drive wheel or deflecting wheel. Advantageously for this purpose the gap is at least 3%, preferably at least 4% and particularly preferably at least 5% of the width of the elevator support means.

For mounting, the elevator support means can be produced from a pre-product, wherein the pre-product consists of two or more elevator support means with a one-piece base body. The pre-product is partly divided between drive ribs and guide ribs so that elevator support means substantially separated in that manner remain connected by way of at least one thin base body web before they are mounted in the elevator system. This facilitates handling thereof and positionally correct arrangement on drive wheel and deflecting wheel. Alternatively, it is possible for mounting to permanently or detachably connect two or more elevator support means with an assembly band before they are mounted in the elevator system.

A drive wheel and/or a deflecting wheel of a elevator system according to an embodiment of the present invention has or have for each drive or guide rib an associated groove in such a manner that when the elevator support means is laid in place the flanks of the drive or guide rib contact corresponding counter-flanks of the associated groove. In this connection the grooves are preferably formed in correspondence with the ribs of the elevator support means: if the guide rib or drive rib has a specific flank height, flank width and/or a specific flank angle, then advantageously the counter-flanks of the associated groove have substantially the same flank height and/or flank width and/or substantially the same flank angle. In particular it is preferred for the penetration depth by which at least one, preferably each, guide rib of a elevator support means according to the present invention penetrates into a groove in a deflecting wheel to be greater than the penetration depth by which the at least one, preferably each, drive rib penetrates into a groove in a drive wheel. In other words, preferably at least one, preferably each, groove in a deflecting wheel is so formed that the projection of the contact surface between a flank of a guide rib arranged in this groove and the corresponding counter-flank of this groove is greater in axial and/or radial direction than the corresponding projection of the contact surface between a flank of at least one, preferably each, drive rib and the corresponding counter-flank of a groove, which is associated with this drive rib, in the drive wheel.

The drive wheel or the drive wheels can have several drive zones which are looped around at least partly by the elevator support means. Advantageously, an elevator support means loops around a drive wheel with an angle of wrap of 180°, preferably less than 180°, preferably less than 150°, particularly preferably less than 120° and especially 90°.

Due to the small bending radii, which are possible, of the elevator support means it is possible to connect the drive with a separate drive pulley or, however, to integrate drive zones in a drive output shaft with a drive. Drive pulleys and drive shafts provided with drive zones are therefore uniformly referred to as drive wheel. Advantageously, the diameter of a drive wheel is less than or equal to 220 millimeters, preferably less than 180 millimeters, preferably less than 140 millimeters, preferably less than 100 millimeters, preferably less than 90 millimeters and preferably less than 80 millimeters. The tension forces are introduced into the belts by the drive wheel in friction-coupling and/or shape-coupling manner.

An elevator support means can be constructed as an endless belt, the ends of which are fastened to belt locks. The belt can, particularly in the case of difficult deflecting conditions, for example be led through openings or placed on belt wheels mounted so as to be non-aligned.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a section through an elevator system according to an embodiment of the present invention;

FIG. 2 shows an elevator support means according to an embodiment of the present invention for explanation of mentioned specifications;

FIG. 3 shows a part section through an elevator support means of the elevator system of FIG. 1, along the line III-III;

FIG. 4 shows a part section through an elevator support means of the elevator system of FIG. 1, along the line IV-IV;

FIG. 5 shows a pre-product of the elevator support means of FIG. 2;

FIG. 6 shows an embodiment of a combination of the elevator support means of FIG. 2, produced from the pre-product of FIG. 5; and

FIG. 7 shows a further embodiment of the combination of the elevator support means of FIG. 2.

### DESCRIPTION OF THE PREFERRED EMBODIMENT

The U.S. provisional patent application Ser. No. 60/822,118 filed Aug. 11, 2006 and U.S. provisional patent application Ser. No. 60/871,869 filed Dec. 22, 2006 are hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

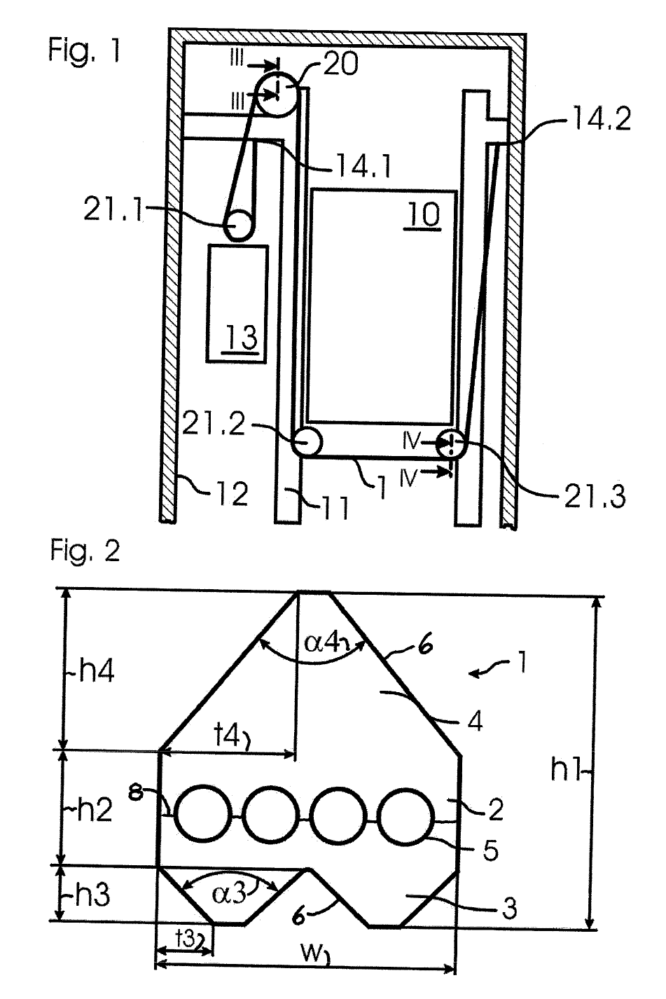

FIG. 1 shows a section through an elevator installation, which is installed in an elevator shaft 12 according to an embodiment of the present invention. This comprises a drive, which is fixed in the elevator shaft 12, with a drive wheel 20, an elevator car 10, which is guided at car guide rails 11, with two deflecting wheels, which are mounted below the car floor, in the form of car support rollers 21.2, 21.3, a counterweight 13 with a further deflecting wheel in the form of a counterweight support roller 21.1 and several elevator support means, which are constructed as wedge-ribbed belts 1, for the elevator car 10 and the counterweight 13, which transmit the drive force from the drive wheel 20 of the drive unit to the elevator car and the counterweight.

Each wedge-ribbed belt 1 is fastened at one of its ends below the drive wheel 20 at a first belt fixing point 14.1. From this it extends downwardly to the counterweight support roller 21.1, loops around this and extends out from this to the drive wheel 20, loops around this and runs downwardly along the car wall of the counterweight side, loops on either side of the elevator car around car support rollers 21.2 and 21.3—which are respectively mounted below the elevator car 10—each time through approximately 90° and runs upwardly along the car wall remote from the counterweight 13 to a second belt fixing point 14.2.

The plane of the drive wheel 20 can be arranged at right angles to the car wall at the counterweight side and its vertical projection can lie outside the vertical projection of the elevator car 10. It is therefore preferred that the drive wheel has a small diameter of less than or equal to 220 millimeters, preferably less than 180 millimeters, preferably less than 140 millimeters, preferably less than 100 millimeters, preferably less than 90 millimeters, and preferably less than 80 millimeters, so that the spacing between the car wall at the counterweight side and the wall of the elevator shaft 12 opposite thereto can be as small as possible. Moreover, a small diameter of the drive wheel 20 enables use of a gearless drive motor with a relatively low drive torque as drive unit. The belt fixing points 14.1, 14.2 are devices which are known to the expert and in which the wedge-ribbed belt 1 is clamped between a wedge and a housing.

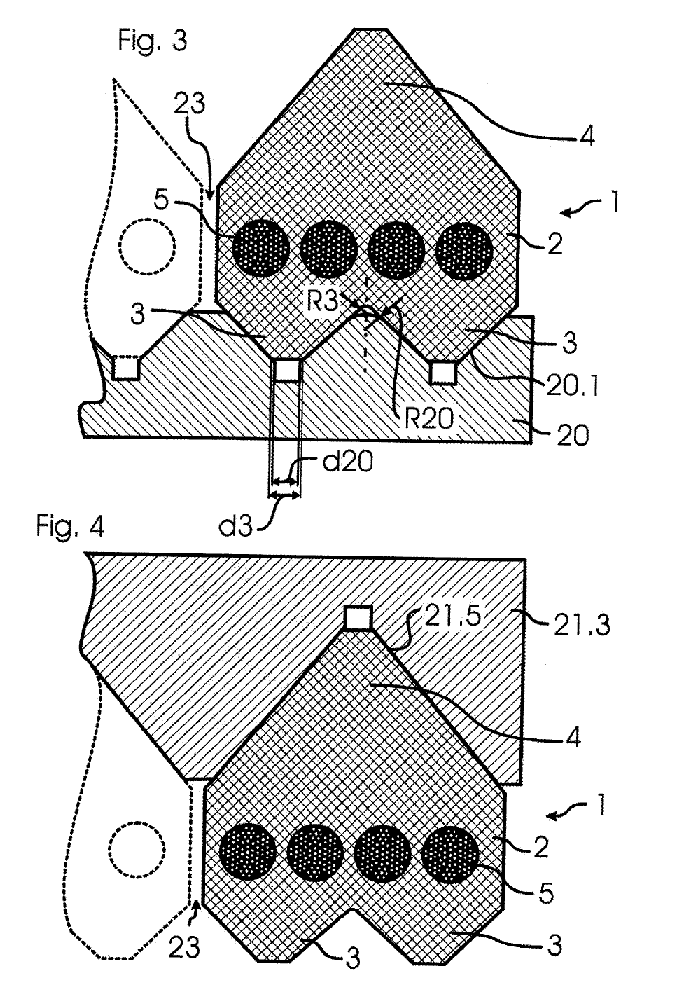

FIGS. 3 and 4 show a section through an elevator support means in the form of a wedge-ribbed belt 1 of FIG. 1 according to an embodiment of the present invention. This comprises a base body 2 in which a tensile carrier arrangement 5 of four tensile carriers is arranged. As indicated in the figures, each tensile carrier is constructed as a steel wire cable which comprises a double-ply core strand with a core wire with 0.19 millimeters diameter, a wire layer, which is wrapped therearound in “S” wrap, of six wires with 0.17 millimeters diameter and a wire layer, which is wrapped therearound similarly in “S” wrap, of twelve wires with 0.17 millimeters diameter, as well as eight single-ply outer strands with a core wire with 0.17 millimeters diameter and a wire layer, which is wrapped therearound in “Z” wrap, of six wires with 0.155 millimeters diameter, which are wrapped in “S” wrap around the core layer.

A drive side (at the bottom in FIG. 3) of the elevator support means 1 is intended for contact with the drive wheel 20 and the counterweight support roller 21.1. It has for this purpose two drive ribs in the form of wedge ribs 3, which, as shown in FIG. 3, engage in associated grooves 20.1 of the drive wheel 20 and are laterally guided by these. The pressing pressure thereby advantageously increases and therewith the traction capability of the drive.

A deflecting side (at the top in FIG. 4) of the elevator support means 1 is intended for contact with the car support rollers 21.2, 21.3 and has for this purpose a guide rib in the form of a wedge rib 4 which, as shown in FIG. 4, engages in an associated groove 21.5 of the deflecting wheel 21.3 and is laterally guided by this.

The dimensional sizes of the elevator support means 1 are schematically shown in FIG. 2. In that case the flank height h3 or h4 of the drive rib 3 or of the guide rib 4 is the projection of the rib onto the median plane of the elevator support means 1, which is spanned by the length axis and height axis (vertical in FIG. 2). The overall height h1 of the elevator support means is thus composed of the flank heights h3, h4 of the drive and guide ribs 3, 4 and the height h2 of the base body 2. Due to this large flank height h4, this total height h1 is greater than the width w of the elevator support means, which advantageously increases the bending stiffness thereof about its transverse axis and thus counteracts jamming in grooves 20.1 or 21.5. In the example of embodiment the ratio w/h1=0.906.

The flank width t3 or t4 of a drive rib 3 or of the guide rib 4 corresponds with the projection of the rib on the base body 2 of the elevator support means 1, i.e. perpendicularly to the flank height (horizontal in FIG. 2). The overall width is denoted by w. The width of a rib results from its two flank widths “t” as well as the width of a (flattened) tip. Thus, the width of the drive rib 3 is, for example, 2×t3+d3 (cf. FIGS. 2, 3).

The flank angle α4 of the guide rib 4 is the internal angle between the two flanks of the guide rib 4 and in the example of embodiment is 80°. The correspondingly defined flank angle α3 of the drive ribs 3 is, in the example of embodiment, 90°.

As recognizable in FIG. 2, the flank height h4 of the one guide rib 4 is greater than the flank height h3 of the two drive ribs 3. The guide rib 4 can thereby, as comparison of FIGS. 3 and 4 shows, penetrate deeper into the associated groove 21.5 in the deflecting wheel 21.3 than is the case with the drive ribs 3 and the associated grooves 20.1 of the drive wheel 20. The guide rib 4 therefore remains, in the case of radial elevatoring off (downwardly in FIG. 4) which can set in, for example, due to the intrinsic weight of the elevator support means 1 in the case of support means slackness, longer in the groove 21.5 and automatically centers the elevator support means 1, after tightening thereof, again on the deflecting wheel 21.3. On the other hand, the maximum spacing of the tensile carriers 5 from the drive side is smaller, so that a more homogenous distribution of force in the drive ribs 3 occurs.

As similarly recognizable in FIG. 2 the flank width t4 of the guide rib 4 is also greater than the flank width t3 of the two drive ribs 3. If the elevator support means on a wheel 20, 21 migrates outwardly by its maximum flank width “t” then it is returned to its position by the inclined flanks. Due to the greater flank width t4 the elevator support means 1 is thus guided at its deflecting side over a wider region in transverse direction. This allows, in particular, also a more pronounced diagonal tension, since even an elevator support means entering at greater inclination is still “captured”, due to its greater flank width, by the corresponding groove 21.5 of the deflecting wheel.

This is particularly advantageous, since, due to mounting tolerances with the deflecting wheels 21.2, 21.3 as well as the small spacing thereof from one another, a more pronounced diagonal tension can occur, which opposes the improved guidance at the deflecting side. In addition, greater tolerances can be accepted between the deflecting wheel 21.3 and the belt fixing point 14.2, since the wider and higher guide rib 4 allows a greater diagonal tension.

Partial compensation can be provided between the drive wheel 20 and the deflecting wheel 21.2 for such diagonal tension by deformation of the elevator support means, so that the shorter and narrower drive ribs 3 run into the drive wheel 20 with smaller diagonal tension.

A guide rib 4 which extends over substantially the entire width w of the elevator support means 1 and is thus approximately twice as wide as the two drive ribs 3 is associated with the two drive ribs 3. In order to further increase the depth of penetration the flank angle α4 of the guide rib 4 is formed, at 80°, to be more acute than the flank angle α3 of the drive ribs 3.

Overall, the guide rib 4 thus has a significantly larger flank area f4=√(t4²+h4²) than the drive ribs 3 at f3=√(t3²+h3²), which significantly improves the guidance at the deflecting side. On the other hand, the tensile carriers 5 are arranged near the drive side, wherein due to the flatter flank angle α3 the spacing from the drive side varies only a little. Since, in addition, two tensile carriers 5 are associated with each drive rib 3, friction forces can be transferred from the drive wheel 20 substantially by way of each flank drive of a drive rib 3 to an associated tensile carrier 5, which has the effect of a particularly homogenous distribution of force in the drive ribs.

As mentioned above, a group of one or more drive ribs can be of multi-part construction with a group of one or more guide ribs. As shown in FIG. 2, the elevator support means 1 is of two-part construction joined at a contact surface 8 from a lower part comprising the drive ribs 3 and an upper part connected therewith and comprising the guide rib 4. Different material characteristics can be provided on the drive side and the deflecting side. For example, the drive side can have a lesser hardness, particularly a lesser Shore hardness, and/or a greater coefficient of friction than the deflecting side so as to achieve better drive capability, whereas conversely the lower coefficient of friction of the deflecting side reduces the energy loss during deflection.

As schematically indicated in FIG. 3, the flattened tip of the drive rib 3 has a width d3, which width d3 is the same width as or wider than the minimum spacing d20 of the two counter-flanks of the groove 20.1 in the drive wheel 20. The edges which are formed in these counter-flanks and at which the inclined counter-flanks go over into a rectangular groove in the groove base thereby do not contact the flanks of the drive ribs 3, so that this is protected against a corresponding notch effect. The same applies to the guide rib 4 and to the groove 21.5 associated therewith as is recognizable in FIG. 4.

On the other hand, the counter-flanks of adjacent grooves 20.1 of the drive wheel go over into one another by a radius R20 which is greater than a radius R3 by which mutually facing flanks of the adjacent drive ribs 3 go over into one another. The contact between the flanks of the drive ribs 3 and the counter-flanks of the grooves 20.1 thus takes place smoothly and without large notch effects.

The drive side can have at least in the regions of its wedge ribs 3, which come into friction couple with the flanks of the drive wheel 20, a covering 6 (FIG. 2) such as a coating with a PA film. Advantageously the entire drive side is coated in a continuous or discontinuous process, which simplifies manufacture. Alternatively to the coating, a vapor deposition and/or flocking covering can also be provided. The vapor deposition is, for example, a metal vapor deposition. The flocking is, for example, a flocking with short synthetic or natural fibers. This vapor deposition or flocking can also extend over the entire drive side and be carried out in a continuous or discontinuous process. In principle, in the case of pairings of wedge ribs and grooves in which only the flanks of the wedge ribs bear against the grooves with friction coupling it is possible to provide only these flanks of the wedge ribs with the covering 6, so that those regions between the rib flanks which are not in contact with the drive wheel 20 are uncoated. In addition, the possibility exists of providing the rib 4 with a covering 6 reducing the coefficient of friction and/or noise.

As indicated in FIGS. 3, 4 by dashed lines, apart from the elevator support means one or several further, preferably constructionally identical, elevator support means are arranged and spaced from one another by a gap 23 which is sufficient to prevent mutual contact of the elevator support means on the drive or deflecting wheels even when the elevator support means deform. Through such an elevator support means combination a desired width of narrow individual elevator support means which are easy to handle can be mounted on site in simple and quick manner, which significantly simplifies production and stock-keeping, transport and mounting and demounting. Due to the construction with two drive ribs 3, with which four tensile carriers are associated, the total load-bearing force of the elevator support means combination can be adapted in fine steps by addition of individual elevator support means. Through the narrow individual elevator support means it can be avoided that an elevator support means combination with “n” elevator support means has to be reinforced by a further wide elevator support means (n+1) by a correspondingly large load-bearing force step and thus significantly over-dimensioned when the load-bearing force, which is made available by “n” elevator support means, is only slightly less than the required total load-bearing force.

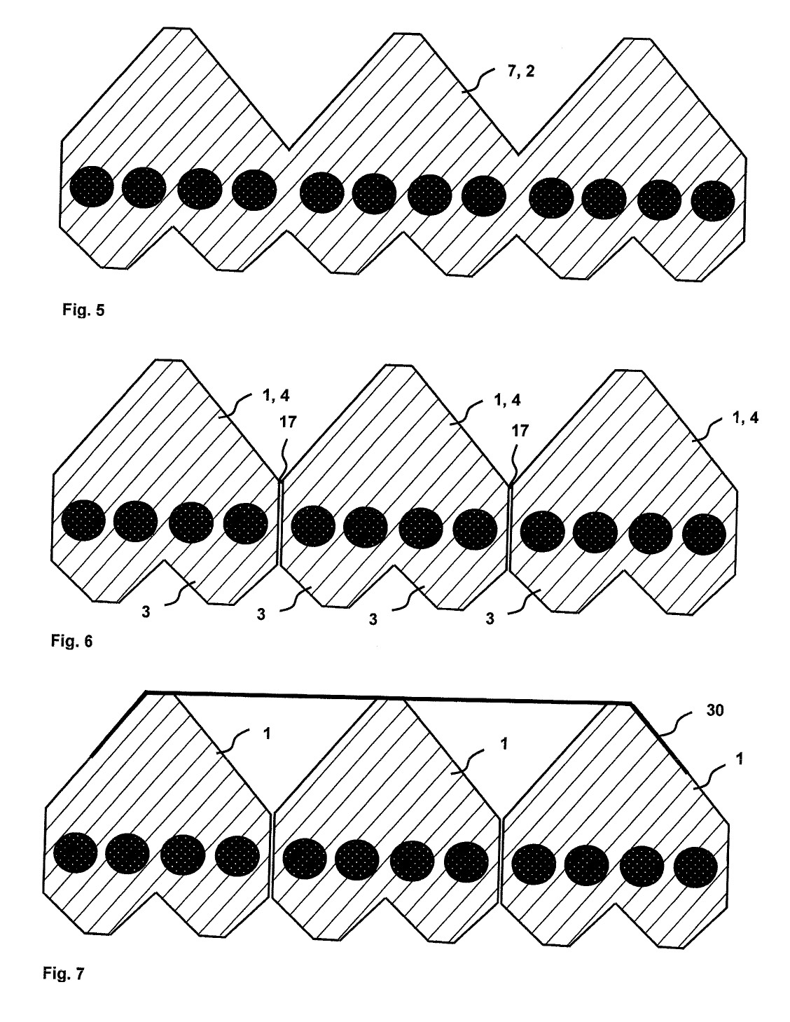

For mounting such an elevator support means combination the elevator support means 1 can be made, as shown in FIGS. 5 and 6, from a pre-product 7. The pre-product 7 consists of two or more elevator support means 1 with a one-piece base body 2. The pre-product 7 is partly divided between drive ribs 3 and/or guide ribs 4 so that elevator support means remain connected by way of at least one thin base body web 17 before they are mounted in the elevator system. According to the embodiment of FIG. 6, three elevator support means 1 are connected together by way of two base body webs 17. The base body webs 17 can, as shown in FIG. 6, be mounted on the deflecting side of the elevator support means 1 so that the drive side of the individual elevator support means 1 is freely accessible even in the composite. In particular, the individual elevator support means 1 in the composite can lie by their drive side in corresponding grooves of the drive wheel 20. In that case the base body webs 17 can also guarantee correct lateral spacing 23 of the elevator support means 1 from one another on the drive wheel 20. For this purpose the elevator support means 1 are connected, at lateral assembly spacings from one another, by way of the base body webs 17, which spacings substantially correspond with the lateral spacings 23 of the individual elevator support means 1 on the drive wheel 20. After mounting has taken place the base body webs 17 can be torn, for example in that the base body webs 17 are slightly shorter than the lateral spacings 23 of the elevator support means 1 on the drive wheel 20 and the base body webs 17 tear in controlled manner under the stress which arises. It is obviously also possible to provide the base body webs 17 on the drive side of the elevator support means 1.

Alternatively, for mounting such an elevator support means composite it is also possible, as shown in FIG. 7, for several elevator support means 1 to be connected together by way of an assembly band 30. The assembly band 30 surrounds the elevator support means 1 at least partly. For example two, three, four, six or eight elevator support means form a composite which is partly surrounded by assembly band 30 and which, rolled up as a loop, can be transported in simple manner and without problems into the elevator shaft 12. The assembly band 30 is, for example, fixed reversibly or irreversibly by material locking to the elevator support means 1. Advantageously, it is a thin plastics material band with an adhesive layer at one side. The plastics material band is connected with the elevator support means 1 by way of the adhesive layer. In the case of reversible material locking the adhesive band can be pulled off the elevator support means 1 and the detached elevator support means thus separated. Advantageously, the assembly band 30 is mounted on the deflecting side of the elevator support means so that the drive side of the individual elevator support means 1 is freely accessible even in the composite. In particular, the individual elevator support means 1 in the combination can lie by way of their drive side in corresponding grooves of the drive wheel 20. In that case the assembly band 30 can also guarantee the correct lateral spacing 23 of the elevator support means from one another on the drive wheel 20. For this purpose, the elevator support means 1 are connected at lateral assembly spacings from one another with the assembly band 30, which spacings substantially correspond with the lateral spacings 23 of the individual elevator support means 1 on the drive wheel 20. It is obviously also possible to mount the assembly band 30 on the drive side of the elevator support means 1.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator support means for an elevator system comprising:
a base body having a drive side and a deflecting side opposite said drive side;
at least one drive rib formed on said drive side;
at least one guide rib formed on said deflecting side; and
a tensile carrier arrangement arranged in said base body, wherein the elevator support means includes at least one of said at least one guide rib having a larger flank height than said at least one drive rib, said at least one guide rib having a greater flank width than said at least one drive rib, a ratio of the flank height of said at least one guide rib to a width of the elevator support means being at least 0.4, a flank angle of said at least one drive rib being greater than a flank angle of said at least one guide rib, and said at least one guide rib being associated with at most three of said at least one drive rib.

2. The elevator support means according to claim 1 wherein a ratio of the flank height of said at least one guide rib to the flank height of said at least one drive rib is at least 1.5.

3. The elevator support means according to claim 1 wherein a ratio of the flank width of said at least one guide rib to the flank width of said at least one drive rib is at least 1.5.

4. The elevator support means according to claim 1 wherein a ratio of the width of the elevator support means to a height of the elevator support means is less than or equal to 0.95.

5. The elevator support means according to claim 1 wherein said drive side includes two or three of said at least one drive rib and said deflecting side has only one of said at least one guide rib.

6. The elevator support means according to claim 1 wherein said at least one drive rib is formed as a wedge rib with a flank angle between 60° and 120°.

7. The elevator support means according to claim 1 wherein said at least one guide rib is formed as a wedge rib with a flank angle between 60° and 100°.

8. The elevator support means according to claim 1 wherein a minimum width of said at least one drive rib is equal to or greater than a minimum width of an associated groove of a drive wheel of the elevator system.

9. The elevator support means according to claim 1 wherein a groove having a predetermined groove radius is formed between an adjacent two of said at least one drive rib, and a ratio of the groove radius to a radius formed on an associated rib of a drive wheel of the elevator system is less than one.

10. The elevator support means according to claim 1 wherein said at least one drive rib has a drive rib base body and said at least one guide rib has a guide rib base body, and at least one of said base bodies is formed from at least one elastomer including polyurethane, polychloroprene, natural rubber and ethylene-propylene-diene rubber.

11. The elevator support means according to claim 1 wherein said at least one of said drive side and said deflecting side has a covering with a coefficient of friction, hardness or abrasion resistance that differs from a coefficient of friction, hardness or abrasion resistance respectively of said base body.

12. The elevator support means according to claim 1 being of multi-part construction wherein said at least one drive rib has at least one of a lesser hardness and a greater coefficient of friction than a hardness and a coefficient of friction respectively of said at least one guide rib.

13. The elevator support means according to claim 1 wherein said tensile carrier arrangement includes at least two tensile carriers positioned adjacent said at least one drive rib.

14. The elevator support means according to claim 1 wherein said at least one tensile carrier has a diameter in a range of 1.5 to 4 millimeters.

15. The elevator support means according to claim 1 wherein a spacing of said tensile carrier arrangement from said drive side is less than a spacing of said tensile carrier arrangement from said deflecting side.

16. The elevator support means according to claim 1 wherein said tensile carrier arrangement includes at least one tensile carrier comprising a double-ply core strand with a core wire and two wire layers wrapped around said core wire, and a plurality of single-ply outer strands which are arranged around said core strand and each including another core wire and another wire layer wrapped around said another core wire.

17. The elevator support means according to claim 16 wherein said two wire layers of said core strand have a same angle of wrap, said another wire layer of each of said outer strands being wrapped with the angle of wrap of said two wire layers, and said outer strands being wrapped opposite to the angle of wrap of said two wire layers and said another wire layer.

18. An elevator system comprising: a car connected to the elevator support means according to claim 1 and a drive wheel co-operating in friction-coupling manner with a drive side of the elevator support means in order to move the car.

19. The elevator system according to claim 18 including a plurality of the elevator support means for moving the car, wherein each of the elevator support means at least partly loops around said drive wheel on said drive side and at least partly loops around a deflecting wheel on said deflecting side, wherein a groove formed on a circumference of said drive wheel is associated with said at least one drive rib and wherein a groove formed on a circumference of said deflecting wheel is associated with said at least one guide rib of each of the elevator support means.

20. The elevator system according to claim 19 wherein two of the elevator support means are spaced apart by a gap.

21. The elevator system according to claim 20 wherein said gap is at least 3% of a width of one of the elevator support means.

22. A method of mounting the elevator support means in the elevator system according to claim 18 comprising the steps of:
a. forming a pre-product including at least two of the elevator support means with said base bodies being integral;
b. partly dividing the integral base bodies between the drive ribs or the guide ribs to form a web; and
c. maintaining the elevator support means connected by the web before mounting in the elevator system.

23. A method of mounting the elevator support means in the elevator system according to claim 18 comprising the steps of:
a. proving an assembly band; and
b. permanently or detachably connecting at least two of the elevator support means with the assembly band before mounting in the elevator system.
